(19) United States
(12) Patent Application Publication
(10) Pub. No.: US 2007/0080829 A1
(43) Pub. Date: Apr. 12, 2007

(54) Method and apparatus in a vehicle for producing and wirelessly transmitting messages to other vehicles

(75) Inventors: Alfred Biesinger, Tubingen (DE); Sieglief Lenart, Ostfildern (DE); Robert Schuessler, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 10/562,703

(22) PCT Filed: Jun. 25, 2004
(86) PCT No.: PCT/EP04/06880

§ 371 Date: Jul. 5, 2006

(30) Foreign Application Priority Data
Jun. 30, 2003 (DE) 103 29 505.4

(51) Int. Cl. G08G 1/123

(52) U.S. Cl. 340/988

(57) ABSTRACT

The invention relates to an apparatus in a vehicle (1) for producing and wirelessly transmitting messages to vehicles (11) which are set up to receive such messages, having a communication means (2) and activation means (3), where activation by the activation means (3) is used to transmit messages from the communication means (2) which comprise at least information about the position and speed of the vehicle (1).

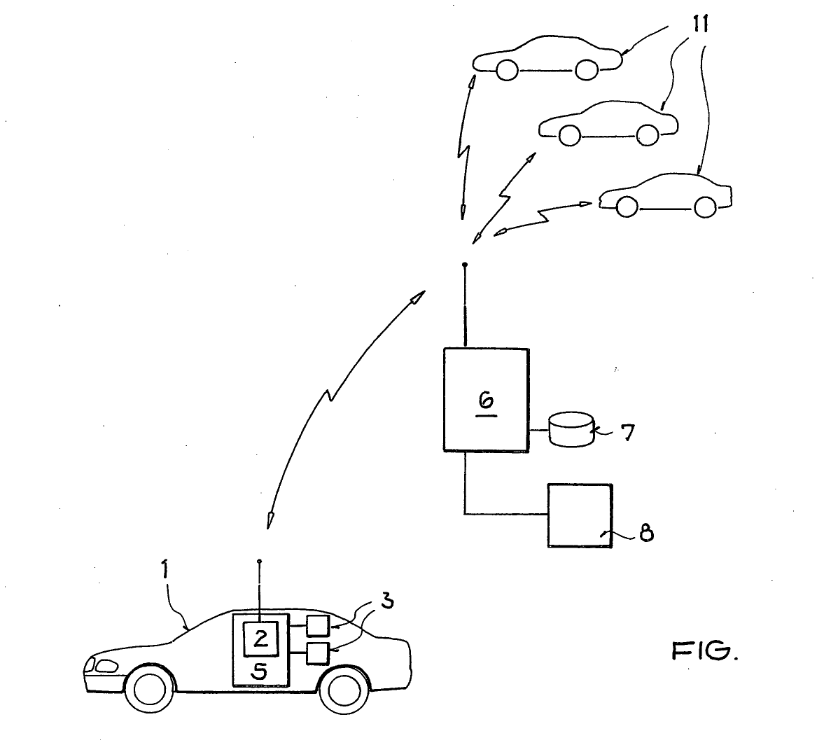

In line with the invention, the communication means (2) is in the form of part of a unit (5) in the vehicle for determining road tolls, the activation means (3) is in the form of a direction-of-travel indicator operating element, and the messages are sent to the vehicles (11) from the communication means (2) using a control center (6) which is set up to manage road tolls.

The invention relates to an apparatus in a vehicle for producing and wirelessly transmitting messages to further vehicles, where the vehicle comprises a communication means and activation means, where activation by the activation means is used to transmit messages from the communication means, and where the messages comprise at least information about the position and speed of the vehicle. By way of example, such an apparatus can be used to provide the driver of a vehicle with a radio-based danger warning as he approaches the location of the danger. The invention also relates to a method for producing messages in the vehicle and wirelessly transmitting them to further vehicles which are set up to receive such messages, in accordance with the precharacterizing part of patent claim 11.

An apparatus of the generic type is presented by DE 100 075 73 C1.

It is an object of the invention to propose an apparatus of the generic type which can be used quickly and easily for interchanging messages between vehicles and in so doing reliably ensures that the vehicles are supplied with messages. It is likewise an object of the invention to specify an associated method.

The object is achieved for the apparatus by the features of patent claim 1 and for the method by the features of patent claim 11. The subclaims relate to advantageous embodiments and developments of the invention.

In line with the invention, the communication means is in the form of part of a unit in the vehicle for determining road tolls, the messages being sent to further vehicles from the communication means using a control center which is set up to manage road tolls, and the activation means is in the form of a direction-of-travel indicator operating element. In other words, the invention proposes designing the apparatus for interchanging messages between vehicles as part of a system for determining road tolls, where the interchange of messages takes place via the control center provided in such a system and where the activation means in the vehicle is in the form of a direction-of-travel indicator operating element, which is already provided in the vehicle.

The introduction of the “HGV toll” means that a system for determining road tolls at least for commercial vehicles is universally available. Very slight modifications allow this existing system to be used for the present invention. Such a system for determining road tolls for sections of a road network which are “subject to a toll” (subsequently called toll roads), for example highways, is described in DE 43 04 838 C2, the disclosure of which is incorporated herein by reference. The vehicle-based part of this system comprises all the components which are required for the invention. Thus, this system contains a communication means for interchanging data with a control center which is set up to manage road tolls, in order to control billing operations for the toll roads used. The vehicle-based part also comprises means for finding the position of the vehicle, for example a receiver for a satellite-assisted position-finding system (for example “GPS”, “Glonass”, or “Galileo”), in order to determine what road the vehicle is using. Such a position-finding means can additionally also be used to determine the speed of the vehicle. Such a vehicle-based system also comprises computation means for executing the production and activation of messages.

The minimum information which the messages produced in line with the invention comprise is the position and speed of the vehicle. Such messages are already used as standard by a system for determining road tolls, for the purpose of control or for billing purposes when toll roads are entered or left. By way of example, incurred charges are determined by sending a message from the vehicle to the control center which comprises position-related information about the entering and leaving of toll roads. Such messages can be converted into messages based on the invention through slight modifications. This merely requires different activation (for producing the messages), and the other steps, such as producing and sending the message, can be used unchanged. The invention therefore makes it particularly easy to use the mechanism of producing and transmitting a position-related message to the control center, which allows messages to be interchanged between vehicles with particularly little complexity. In this case, the information about the speed of the vehicle is provided by the position-finding means, for example, or is supplied by means of a speed sensor in the vehicle which has a data-processing link, the speed also being able to comprise a time profile and/or the direction of travel of the vehicle.

The invention makes better use of a system for determining road tolls and improves acceptance by producing messages. By using a direction-of-travel indicator operating element as an activation means, the invention ensures that the driver of the vehicle does not need to take any additional action. Rather, operations which a driver performs “as standard” in certain situations are used as a trigger for the activation.

In addition, the inventive use of the control center ensures that vehicles are reliably supplied with messages. Conventionally, messages are interchanged between vehicles using a short-range communication means. In this case, there is a limitation through the physical circumstances of this communication means (propagation of the message frequency used), and targeted addressing of vehicle groups (which have been located in arbitrary fashion) is not possible. By contrast, the use of a control center allows such targeted addressing of vehicles or vehicle groups. In addition, the use of the control center allows centralized and simple further processing of received messages. By way of example, provision may be made for a message (other than breakdown messages) first to be confirmed by a second vehicle which is equipped in line with the invention before it is made available to further vehicles by the control center. This allows a particularly high quality of messages. In addition, the use of the control center makes it possible to use powerful computer systems with comprehensive databases, which is not possible in the vehicle, for example for the further processing of the messages. It is also a particularly simple matter to associate messages with lanes or directions of travel, for example by means of a calculation operation, e.g. from at least two messages with different positions.

In one particularly advantageous embodiment of the invention, the direction-of-travel indicator operating element is in the form of a hazard warning system switch. The invention thus becomes implementable using a simple data-processing connection between the hazard warning system switch and the vehicle-based part of the system for determining road tolls. A hazard warning system switch is usually operated by the driver of a vehicle when the vehicle approaches the end of a tailback and needs to brake as a result of this. In addition, a hazard warning system switch is usually operated by the driver when a vehicle is stranded or when a vehicle is traveling particularly slowly in comparison with other vehicles, for example a vehicle combination or a heavy commercial vehicle on an incline. The vehicle driver's usual action in such critical or potentially critical situations transmits a message automatically in line with the invention. The driver of the vehicle does not need to perform any complicated, further actions.

It is possible to distinguish the cause of a message produced in line with the invention by the hazard warning system switch easily using the speed of the vehicle which is producing the message. By way of example, the vehicle is approaching the end of a tailback if the speed is reduced greatly and the hazard warning system is turned on. A broken-down vehicle has a speed of zero. If the speed is uniformly low, a vehicle with the hazard warning system turned on is traveling particularly slowly in comparison with other vehicles, for example. In addition, highly accurate position information can be used to determine, by way of example, whether the vehicle is at a standstill in a lane in the “tailback case” or on the shoulder in the “breakdown case”. In addition, the length of time for which the hazard warning system is turned on and/or information from a digital road map (for example whether there is an inclination reducing the speed of the vehicle at the position of the message) can also be used to distinguish the cause of the message produced. Appropriate determination of the cause of a message can be provided either in the vehicle or the control center, with it naturally also being possible to have a combination of both options.

In a further, particularly advantageous embodiment, provision is made for the direction-of-travel indicator operating element to be in the form of a direction indicator switch. A direction indicator switch is usually operated when an overtaking operation is initiated or ended or when turning off from a road. This information can be used in the control center, for example, to determine a corresponding overtaking operation by the reporting vehicle or a corresponding exit by the reporting vehicle from the road. By way of example, if the vehicle is a commercial vehicle, it can be concluded upon initiation of the overtaking operation that there is a resultant at least brief disturbance in the overtaking lane. Upon detection of the vehicle turning off from the road, for example using a digital road map in the vehicle and/or in the control center, it is possible to detect the position of this turn-off. If this position corresponds to the entrance to a vehicle park, it is possible to use the corresponding message, for example by summing all the relevant messages, to determine the use of the vehicle park by vehicles. If the position corresponds to a highway exit, for example, the corresponding messages can be used to determine that a road which adjoins the exit is under load, for example.

Advantageously, the vehicles which are set up to receive the inventive messages are likewise equipped with a unit in the vehicle for determining road tolls. This makes it possible to use the inventive messages in these vehicles without further installed units by using just a unit which is already present to determine road tolls in the vehicle.

The received messages are output in the vehicle visually, audibly and/or haptically. An example of a visual output is a display. This display may be provided as part of the unit for determining road tolls and/or may be in the form of a separate display in the vehicle. Audible output of received messages is implemented by means of voice output, for example. In this case, it is also possible for an indication to be provided regarding the cause of a received message being produced. An example of a visual output is a flashing symbol at the position covered by the received message on the display of the navigation system in the receiving vehicle. An example of audible output is a “The Albhöhe vehicle park is full” output via the audio system of the vehicle receiving the message.

It is advantageously proposed that the control center can additionally actuate means for outputting collective traffic information. Such means are actuated using data which are determined in the control center from the messages received from vehicles. Examples of actuatable means for outputting collective traffic information are dynamic traffic signs (e.g. gantries) or else collective wireless information (e.g. “cell broadcast” in a mobile radio network). This also allows drivers of vehicles which do not include any facility for receiving the inventively produced messages to use such messages.

The inventive apparatus is easy to implement if the communication means is a mobile telephone. The use of a mobile telephone, for example based on the GSM or UMTS standard, ensures almost universal use of the invention, since mobile telephones can be used practically anywhere as a result of the wide spread of appropriate mobile radio networks.

One advantageous development of the invention provides an online billing facility for sent and/or received messages. Thus, by way of example the driver of a vehicle with an inventive apparatus may be rewarded if he agrees to inventive messages being sent from his apparatus. Alternatively, or additionally, provision is made for the driver of a vehicle to have to pay an appropriate charge for a received message.

The invention will now be described in more detail with reference to a drawing, which schematically shows the design of the inventive apparatus. The figure shows a vehicle 1 containing a vehicle-based unit 5 for determining road tolls, with the unit 5 comprising a communication means 2. It likewise shows activation means 3 in the vehicle 1. In addition, a control center 6 which is set up to manage road tolls and which has a digital road map 7 and actuated collective traffic information means 8 is shown, together with further vehicles 11 which are set up to receive inventive messages.

The vehicle-based unit 5 in the vehicle 1 for determining road tolls has a data-processing connection to two activation means 3 which are in the form of direction-of-travel indicator operating elements. A first direction-of-travel indicator operating element 3 is in the form of a hazard warning system switch and a second direction-of-travel indicator operating element 3 is in the form of a direction indicator switch. The direction-of-travel indicator operating elements 3 are used by the driver of the vehicle 1 in the usual way. By way of example, the hazard warning system switch 3 is used by the driver of the vehicle 1 when his vehicle has broken down and he needs to stop on the shoulder of the highway or when the vehicle is approaching the end of a tailback and needs to brake hard. In line with the invention, such a control operation, which is usually performed by the driver of the vehicle 1, automatically produces and transmits a message. To this end, the unit 5 in the vehicle for determining road tolls is used to produce a message which at least comprises information about the position and speed of the vehicle 1. This information is calculated in the usual manner by a unit for determining road tolls. This calculation and production of a message is already performed as standard by unit 5, in order to determine the road toll which is incurred for a toll road on which the vehicle is traveling. Hence, the usual mechanism implemented by the unit 5 for the purpose of producing messages has its function changed to produce inventive messages. To this end, apart from a data-processing connection between the direction-of-travel indicator operating elements 3 and the unit 5, there is no further action required on the vehicle 1. Only small changes in the control functions in the unit 5 (software changes) are still necessary in order to use a unit 5 in the vehicle for determining road tolls in line with the invention. The activation is thus not brought about by entering or leaving a toll road but rather by virtue of the driver activating a direction-of-travel indicator operating element 3.

The messages produced are sent wirelessly via a mobile telephone 2 to a control center 6 which is set up to manage road tolls. This control center also requires just slight modifications. Thus, the inventively produced messages are identified and are processed separately from the road-toll-related messages. If more than one activation means 3 is provided, the messages produced by the vehicle 1 then comprise additional information making it possible to establish that activation means 3 from which the message produced originates.

The control center 6 sends the received messages to vehicles 11 which are set up to receive such messages. In this case, the control center 6 acts merely as a “relay station” by using the mobile radio network to distribute such messages. This allows very targeted and location-specific association of messages. By way of example, such messages are transmitted only to vehicles 11 which are located within a particular area, for example a short distance ahead of a tailback. In addition, provision may be made for these messages to be delivered only to vehicles 11 which have paid a specific charge and/or likewise have a unit 5 for determining road tolls which is set up in line with the invention and which have likewise agreed to the sending of inventive messages. To process such messages, the control center 6 also uses a digital road map. This allows “right” indicator flashing to be identified as leaving the highway to enter a vehicle park, for example. This makes it possible to determine the use of a vehicle park.

In addition, provision is made for the control center 6 to actuate means for outputting collective traffic information 8. Examples of such means are dynamic variable traffic signs which are fitted on gantries over the highway or a “cell broadcast” in a mobile radio network. This allows the use of inventively produced messages even by vehicles 11 which do not have their own apparatus for receiving and presenting such messages.

The inventive apparatus is used in a fleet of vehicles, for example heavy commercial vehicles from 12 tons upward, which have a unit 5 for determining road tolls. This allows the invention to be used particularly quickly and easily merely through slight modifications in a respective vehicle 1, 11, on the unit 5 and at the control center 6 for managing the road tolls. This achieves great universal coverage immediately. Alternatively or in addition, provision is made for the messages also to be able to be received by vehicles 11 which do not have a unit 5. Examples of these are commercial vehicles without a unit 5 for determining road tolls and/or private cars. In this case, provision is made for these vehicles to be equipped with a unit which is set up merely to receive the inventively produced messages. These received messages are then likewise output visually, audibly and/or haptically in the vehicle.

The inventive apparatus allows universal equipment of vehicles which are set up for wirelessly transmitting messages. This allows a high level of message quality to be achieved, since both a high level of universal coverage and the multiplicity of equipped vehicles provide a relatively high frequency of an equipped vehicle detecting the end of a tailback, for example.

Since the messages produced are not sent immediately from the vehicle 1 to further vehicles 11, but rather a control center 6 is “interposed”, it is possible to produce very high-quality messages. By way of example, this is done by providing for the control center 6 not to retransmit an incoming message which describes the end of a tailback immediately, but rather to wait for a further message for confirmation first. If such a message arrives, for example within a prescribable period of time, and hence the first message is confirmed then the control center 6 sends the message about the particular end of tailback to the vehicles 11. This prevents chance events from resulting in a tailback being assumed. In addition, the control center 6 allows received messages to be post-processed. By way of example, messages which relate to a turn-off operation to a vehicle park on a highway can be summed. In this way, it is possible to determine the use of a vehicle park. The use of the control center 6 likewise allows the high-quality messages produced to be priced. This can be done using the billing system for example, which is also used to determine the road tolls.

Since the unit for determining road tolls is currently provided only for use in commercial vehicles, the effect of the invention is increased further. This is because commercial vehicles have a different driving behavior and different driving dynamics than private cars. By way of example, commercial vehicles do not overtake as often as private cars. On the other hand, if a commercial vehicle performs an overtaking operation, this frequently means a disturbance, particularly in dense traffic. The almost universal equipment of commercial vehicles with the unit 5 for determining road tolls thus allows a significant trigger for disturbances in flowing traffic to be monitored “universally”. This allows the inventively produced messages preferably also to be used for further purposes, for example for appraising traffic standstills which occur. Such information can then be forwarded to the police or to radio stations, for example.

Provision may also be made for not every message received by the control center to be forwarded to further vehicles. By way of example, conflicting messages (e.g. “left” indicator flashing in the left-hand lane) may not be forwarded. Alternatively, or in addition, provision is made for specific messages to be forwarded only to selected recipients, e.g. breakdown messages may be forwarded only to a breakdown center.

Finally, it will be noted that the invention can be used universally, i.e. both on highways and main roads and in built-up areas.

Method and apparatus in a vehicle for producing and wirelessly transmitting messages to other vehicles.

### BACKGROUND AND SUMMARY OF THE INVENTION

The invention relates to an apparatus in a vehicle for producing and wirelessly transmitting messages to further vehicles, where the vehicle includes a communication device and an activation device. The activation device is used to transmit messages from the communication device, and the messages include at least information about the position and speed of the vehicle. By way of example, such an apparatus can be used to provide the driver of a vehicle with a radio-based danger warning as he approaches the location of the danger. The invention also relates to a method for producing messages in the vehicle and wirelessly transmitting them to further vehicles which are set up to receive such messages.

An apparatus of the generic type is presented by German Patent Document DE 100 075 73 C1.

It is an object of the invention to propose an improved apparatus which can be used quickly and easily for interchanging messages between vehicles and in so doing reliably ensures that the vehicles are supplied with messages. It is likewise an object of the invention to specify an associated method.

According to the invention, the communication device is in the form of part of a unit in the vehicle for determining road tolls, the messages being sent to further vehicles from the communication device using a control center which is set up to manage road tolls, and the activation device is in the form of a direction-of-travel indicator operating element. In other words, the invention proposes designing the apparatus for interchanging messages between vehicles as part of a system for determining road tolls, where the interchange of messages takes place via the control center provided in such a system and where the activation means in the vehicle is in the form of a direction-of-travel indicator operating element, which is already provided in the vehicle.

The introduction of the “HGV toll” allowed a system for determining road tolls at least for commercial vehicles to be universally available. Modifications allow this existing system to be used for the present invention. Such a system for determining road tolls for sections of a road network which are “subject to a toll” (subsequently called toll roads), for example highways, is described in German Patent Document DE 43 04 838 C2, the disclosure of which is incorporated herein by reference. The vehicle-based part of this system includes the components which are required for the invention. Thus, this system contains a communication device for interchanging data with a control center which is set up to manage road tolls, in order to control billing operations for the toll roads used. The vehicle-based part also includes a device for finding the position of the vehicle, for example a receiver for a satellite-assisted position-finding system (for example “GPS”, “Glonass”, or “Galileo”), in order to determine what road the vehicle is using. Such a position-finding means can additionally also be used to determine the speed of the vehicle. Such a vehicle-based system also includes a computation device for executing the production and activation of messages.

The minimum information which the messages produced in line with the invention comprise is the position and speed of the vehicle. Such messages are already used as standard by a system for determining road tolls, for the purpose of control or for billing purposes when toll roads are entered or left. By way of example, incurred charges are determined by sending a message from the vehicle to the control center which comprises position-related information about the entering and leaving of toll roads. Such messages can be converted into messages based on the invention through slight modifications. This merely requires different activation (for producing the messages), and the other steps, such as producing and sending the message, can be used unchanged. The invention therefore makes it particularly easy to use the mechanism of producing and transmitting a position-related message to the control center, which allows messages to be interchanged between vehicles with particularly little complexity. In this case, the information about the speed of the vehicle is provided by the position-finding device, for example, or is supplied by a speed sensor in the vehicle which has a data-processing link, the speed also being able to comprise a time profile and/or the direction of travel of the vehicle.

The invention makes better use of a system for determining road tolls and improves acceptance by producing messages. By using a direction-of-travel indicator operating element as an activation device, the invention ensures that the driver of the vehicle does not need to take any additional action. Rather, operations which a driver performs “as standard” in certain situations are used as a trigger for the activation.

In addition, the inventive use of the control center ensures that vehicles are reliably supplied with messages. Conventionally, messages are interchanged between vehicles using a short-range communication device. In this case, there is a limitation through the physical circumstances of this communication device (propagation of the message frequency used), and targeted addressing of vehicle groups (which have been located in arbitrary fashion) is not possible. By contrast, the use of a control center allows such targeted addressing of vehicles or vehicle groups. In addition, the use of the control center allows centralized and simple further processing of received messages. By way of example, provision may be made for a message (other than breakdown messages) first to be confirmed by a second vehicle which is equipped in accordance with the invention before it is made available to further vehicles by the control center. This allows a particularly high quality of messages. In addition, the use of the control center makes it possible to use powerful computer systems with comprehensive databases, which is not possible in the vehicle, for example for the further processing of the messages. It is also a particularly simple matter to associate messages with lanes or directions of travel, for example by means of a calculation operation, e.g. from at least two messages with different positions.

In one particularly advantageous embodiment of the invention, the direction-of-travel indicator operating element is in the form of a hazard warning system switch. The invention thus becomes implementable using a simple data-processing connection between the hazard warning system switch and the vehicle-based part of the system for determining road tolls. A hazard warning system switch is usually operated by the driver of a vehicle when the vehicle approaches the end of a tailback and needs to brake as a result of this. In addition, a hazard warning system switch is usually operated by the driver when a vehicle is stranded or when a vehicle is traveling particularly slowly in comparison with other vehicles, for example a vehicle combination or a heavy commercial vehicle on an incline. The vehicle driver's usual action in such critical or potentially critical situations transmits a message automatically according to the invention. The driver of the vehicle does not need to perform any complicated, further actions.

It is possible to distinguish the cause of a message produced according to the invention by the hazard warning system switch easily using the speed of the vehicle which is producing the message. By way of example, the vehicle is approaching the end of a tailback if the speed is reduced greatly and the hazard warning system is turned on. A broken-down vehicle has a speed of zero. If the speed is uniformly low, a vehicle with the hazard warning system turned on is traveling particularly slowly in comparison with other vehicles, for example. In addition, highly accurate position information can be used to determine, by way of example, whether the vehicle is at a standstill in a lane in the “tailback case” or on the shoulder in the “breakdown case”. In addition, the length of time for which the hazard warning system is turned on and/or information from a digital road map (for example whether there is an inclination reducing the speed of the vehicle at the position of the message) can also be used to distinguish the cause of the message produced. Appropriate determination of the cause of a message can be provided either in the vehicle or the control center, with it naturally also being possible to have a combination of both options.

In a further, particularly advantageous embodiment, provision is made for the direction-of-travel indicator operating element to be in the form of a direction indicator switch. A direction indicator switch is usually operated when an overtaking operation is initiated or ended or when turning off from a road. This information can be used in the control center, for example, to determine a corresponding overtaking operation by the reporting vehicle or a corresponding exit by the reporting vehicle from the road. By way of example, if the vehicle is a commercial vehicle, it can be concluded upon initiation of the overtaking operation that there is a resultant at least brief disturbance in the overtaking lane. Upon detection of the vehicle turning off from the road, for example using a digital road map in the vehicle and/or in the control center, it is possible to detect the position of this turn-off. If this position corresponds to the entrance to a vehicle park, it is possible to use the corresponding message, for example by summing all the relevant messages, to determine the use of the vehicle park by vehicles. If the position corresponds to a highway exit, for example, the corresponding messages can be used to determine that a road which adjoins the exit is under load, for example.

Advantageously, the vehicles which are set up to receive the inventive messages are likewise equipped with a unit in the vehicle for determining road tolls. This makes it possible to use the inventive messages in these vehicles without further installed units by using just a unit which is already present to determine road tolls in the vehicle.

The received messages are output in the vehicle visually, audibly and/or haptically. An example of a visual output is a display. This display may be provided as part of the unit for determining road tolls and/or may be in the form of a separate display in the vehicle. Audible output of received messages is implemented by means of voice output, for example. In this case, it is also possible for an indication to be provided regarding the cause of a received message being produced. An example of a visual output is a flashing symbol at the position covered by the received message on the display of the navigation system in the receiving vehicle. An example of audible output is a “The Albhöhe vehicle park is full” output via the audio system of the vehicle receiving the message.

It is advantageously proposed that the control center can additionally actuate a device for outputting collective traffic information. Such devices are actuated using data which are determined in the control center from the messages received from vehicles. Examples of an actuatable device for outputting collective traffic information include dynamic traffic signs (e.g. gantries) or else collective wireless information (e.g. “cell broadcast” in a mobile radio network). This also allows drivers of vehicles which do not include any facility for receiving the inventively produced messages to use such messages.

The inventive apparatus is easily implemented if the communication means is a mobile telephone. The use of a mobile telephone, for example based on the GSM or UMTS standard, ensures almost universal use of the invention, since mobile telephones can be used practically anywhere as a result of the wide spread of appropriate mobile radio networks.

One advantageous development of the invention provides an online billing facility for sent and/or received messages. Thus, by way of example the driver of a vehicle with an inventive apparatus may be rewarded if he agrees to messages according to the present invention being sent from his apparatus. Alternatively, or additionally, provision is made for the driver of a vehicle to have to pay an appropriate charge for a received message.

### BRIEF DESCRIPTION OF THE DRAWINGS

The invention will now be described in more detail with reference to the sole FIGURE, which schematically shows the design of the inventive apparatus.

### DETAILED DESCRIPTION OF THE INVENTION

The FIGURE shows a vehicle 1 containing a vehicle-based unit 5 for determining road tolls, with the unit 5 comprising a communication device 2. It likewise shows an activation device 3 in the vehicle 1. In addition, a control center 6 which is set up to manage road tolls and which has a digital road map 7 and an actuated collective traffic information device 8 is shown, together with further vehicles 11 which are set up to receive inventive messages.

The vehicle-based unit 5 in the vehicle 1 for determining road tolls has a data-processing connection to two activation devices 3 which are in the form of direction-of-travel indicator operating elements. A first direction-of-travel indicator operating element 3 is in the form of a hazard warning system switch and a second direction-of-travel indicator operating element 3 is in the form of a direction indicator switch. The direction-of-travel indicator operating elements 3 are used by the driver of the vehicle 1 in the usual way. By way of example, the hazard warning system switch 3 is used by the driver of the vehicle 1 when his vehicle has broken down and he needs to stop on the shoulder of the highway or when the vehicle is approaching the end of a tailback and needs to brake hard. In line with the invention, such a control operation, which is usually performed by the driver of the vehicle 1, automatically produces and transmits a message. To this end, the unit 5 in the vehicle for determining road tolls is used to produce a message which at least includes information about the position and speed of the vehicle 1. This information is calculated in the usual manner by a unit for determining road tolls. This calculation and production of a message is already performed as standard by unit 5, in order to determine the road toll which is incurred for a toll road on which the vehicle is traveling. Hence, the usual mechanism implemented by the unit 5 for the purpose of producing messages has its function changed to produce inventive messages. To this end, apart from a data-processing connection between the direction-of-travel indicator operating elements 3 and the unit 5, there is no further action required on the vehicle 1. Only small changes in the control functions in the unit 5 (software changes) are still necessary in order to use a unit 5 in the vehicle for determining road tolls in line with the invention. The activation is thus not brought about by entering or leaving a toll road but rather by virtue of the driver activating a direction-of-travel indicator operating element 3.

The messages produced are sent wirelessly via a mobile telephone 2 to a control center 6 which is set up to manage road tolls. This control center also requires just slight modifications. Thus, the inventively produced messages are identified and are processed separately from the road-toll-related messages. If more than one activation device 3 is provided, the messages produced by the vehicle 1 then comprise additional information making it possible to establish that activation device 3 from which the message produced originates.

The control center 6 sends the received messages to vehicles 11 which are set up to receive such messages. In this case, the control center 6 acts merely as a “relay station” by using the mobile radio network to distribute such messages. This allows very targeted and location-specific association of messages. By way of example, such messages are transmitted only to vehicles 11 which are located within a particular area, for example a short distance ahead of a tailback. In addition, provision may be made for these messages to be delivered only to vehicles 11 which have paid a specific charge and/or likewise have a unit 5 for determining road tolls which is set up in line with the invention and which have likewise agreed to the sending of inventive messages. To process such messages, the control center 6 also uses a digital road map. This allows “right” indicator flashing to be identified as leaving the highway to enter a vehicle park, for example. This makes it possible to determine the use of a vehicle park.

In addition, provision is made for the control center 6 to actuate the device for outputting collective traffic information 8. Examples of such means are dynamic variable traffic signs which are fitted on gantries over the highway or a “cell broadcast” in a mobile radio network. This allows the use of inventively produced messages even by vehicles 11 which do not have their own apparatus for receiving and presenting such messages.

The inventive apparatus is used in a fleet of vehicles, for example heavy commercial vehicles from 12 tons upward, which have a unit 5 for determining road tolls. This allows the invention to be used particularly quickly and easily merely through slight modifications in a respective vehicle 1, 11, on the unit 5 and at the control center 6 for managing the road tolls. This achieves great universal coverage immediately.

Alternatively or in addition, provision is made for the messages also to be able to be received by vehicles 11 which do not have a unit 5. Examples of these are commercial vehicles without a unit 5 for determining road tolls and/or private cars. In this case, provision is made for these vehicles to be equipped with a unit which is set up merely to receive the inventively produced messages. These received messages are then likewise output visually, audibly and/or haptically in the vehicle.

The inventive apparatus allows universal equipment of vehicles which are set up for wirelessly transmitting messages. This allows a high level of message quality to be achieved, since both a high level of universal coverage and the multiplicity of equipped vehicles provide a relatively high frequency of an equipped vehicle detecting the end of a tailback, for example.

Since the messages produced are not sent immediately from the vehicle 1 to further vehicles 11, but rather a control center 6 is “interposed”, it is possible to produce very high-quality messages. By way of example, this is done by providing for the control center 6 not to retransmit an incoming message which describes the end of a tailback immediately, but rather to wait for a further message for confirmation first. If such a message arrives, for example within a prescribable period of time, and hence the first message is confirmed then the control center 6 sends the message about the particular end of tailback to the vehicles 11. This prevents chance events from resulting in a tailback being assumed. In addition, the control center 6 allows received messages to be post-processed. By way of example, messages which relate to a turn-off operation to a vehicle park on a highway can be summed. In this way, it is possible to determine the use of a vehicle park. The use of the control center 6 likewise allows the high-quality messages produced to be priced. This can be done using the billing system for example, which is also used to determine the road tolls.

Since the unit for determining road tolls is currently provided only for use in commercial vehicles, the effect of the invention is increased further. This is because commercial vehicles have a different driving behavior and different driving dynamics than private cars. By way of example, commercial vehicles do not overtake as often as private cars. On the other hand, if a commercial vehicle performs an overtaking operation, this frequently means a disturbance, particularly in dense traffic. The almost universal equipment of commercial vehicles with the unit 5 for determining road tolls thus allows a significant trigger for disturbances in flowing traffic to be monitored “universally”. This allows the inventively produced messages preferably also to be used for further purposes, for example for appraising traffic standstills which occur. Such information can then be forwarded to the police or to radio stations, for example.

Provision may also be made for not every message received by the control center to be forwarded to further vehicles. By way of example, conflicting messages (e.g. “left” indicator flashing in the left-hand lane) may not be forwarded. Alternatively, or in addition, provision is made for specific messages to be forwarded only to selected recipients, e.g. breakdown messages may be forwarded only to a breakdown center.

Finally, it will be noted that the invention can be used universally, i.e. both on highways and main roads and in built-up areas.

1-13. (canceled)

14. An apparatus in a first vehicle for producing and wirelessly transmitting messages to at least one second vehicle configured to receive said messages, said apparatus comprising:
a communication device outputting said messages and said communication device including a unit for determining road tolls;
an activation device including a direction-of-travel indicator operating element, said activation device transmitting said messages from the communication device, said messages comprising at least information about the position and speed of the first vehicle; and
a control center for controlling and sending said messages from the communication device to the at least one second vehicle, wherein said control center is configured to manage road tolls.

15. The apparatus as claimed in claim 14, wherein the direction-of-travel indicator operating element is at least one of a hazard warning system switch and a direction indicator switch.

16. The apparatus as claimed in claim 14, wherein the messages activated by the hazard warning system switch are used in the control center to determine at least one of tail lift and a slow-moving vehicle and a broken-down vehicle.

17. The apparatus as claimed in claim 15, wherein the messages activated by the direction indicator switch are used in the control center to detect at least one of an overtaking operation by the first vehicle and a parked vehicle.

18. The apparatus as claimed in claim 14, wherein the control center includes a digital road map.

19. The apparatus as claimed in claim 14, wherein at least on of said at least one second vehicle is configured to receive the messages also includes a unit for determining road tolls.

20. The apparatus as claimed in claim 14, wherein received messages can be output in said first and second at least one of visually, audibily and haptically.

21. The apparatus as claimed in claim 14, wherein the control center actuates a device for outputting collective traffic information.

22. The apparatus as claimed in claim 14, wherein the communication device is a mobile telephone.

23. The apparatus as claimed in claim 14, further including an online billing facility for at least one of sent and received messages.

24. A method for producing messages in a first vehicle and wirelessly transmitting said messages to at least a second vehicle wherein said at least one second vehicle is configured to receive said messages, where activation by a driver of the first vehicle is followed by transmission of the message, said messages including at least information about the position and speed of the first vehicle, said method comprising the steps:
automatically sending the message from a unit in the first vehicle for determining road tolls to a control center which is configured to manage road tolls after the driver of the first vehicle has activated a direction-of-travel indicator operating element; and
forwarding the message from the control center to the at least one second vehicle after said message has been received by said control center.

25. The method as claimed in claim 24, wherein the control center forwards a message to the at least one second vehicle only after at least one further message of the same type has been received.

26. The method as claimed in claim 24, wherein provision is made for received messages to be forwarded in the control center.

27. The apparatus as claimed in claim 15, wherein the control center includes a digital road map.

28. The apparatus as claimed in claim 16, wherein the control center includes a digital road map.

29. The apparatus as claimed in claim 15, wherein at least on of said at least one second vehicle is configured to receive the messages also includes a unit for determining road tolls.

30. The apparatus as claimed in claim 16, wherein at least on of said at least one second vehicle is configured to receive the messages also includes a unit for determining road tolls.

31. The apparatus as claimed in claim 15, wherein received messages can be output in said first and second at least one of visually, audibily and haptically.

32. The apparatus as claimed in claim 16, wherein received messages can be output in said first and second at least one of visually, audibily and haptically.
